(19) United States
(12) Patent Application Publication
(10) Pub. No.: US 2026/0216962 A1
(43) Pub. Date: Jul. 30, 2026

(54) DEVICE AND METHOD FOR CONNECTING AN END OF A FIRST FOIL AND AN END OF A SECOND FOIL

(71) Applicant: Fuji Seal International, Inc., Osaka-shi (JP)

(72) Inventor: Joop Peeters, Deurne (NL)

(73) Assignee: Fuji Seal International, Inc., Osaka-shi (JP)

(21) Appl. No.: 19/148,748

(22) PCT Filed: Jan. 9, 2024
(86) PCT No.: PCT/IB2024/050189

§ 371 Date: Jul. 17, 2025

(30) Foreign Application Priority Data
Jan. 19, 2023 (NL) 2033990

(51) Int. Cl. B29C 65/00; B29C 65/50; B29C 65/78; B65H 19/18

(52) U.S. Cl. CPC B29C 66/853; B29C 65/5042; B29C 65/7817; B29C 65/7832; B65H 19/1852

(57) ABSTRACT

A device for connecting an end of a first foil and an end of a second foil is provided, the device comprising: a frame, a first foil supply arranged to supply the first foil at a first position, a second foil supply arranged to supply the end of the second foil at a second position, and a carriage sub frame mounted to the frame so as to be movable with respect to the frame between the first position at which the first foil is supplied and the second position at which the end of the second foil is positioned. The carriage sub frame supports at least a foil end holding unit arranged for holding the end of the first foil supplied from the first foil supply. A foil edge sensor for detecting a longitudinal edge of the second foil at the second position is mounted on the carriage sub frame.

### TECHNICAL FIELD

The present invention relates to a device for connecting an end of a first foil and an end of a second foil, and a method for connecting an end of a first foil and an end of a second foil.

### BACKGROUND ART

Document EP 2 825 371 B1 discloses a device and method for connecting two ends of foil by means of adhesive tape. The device comprises a frame, a first foil supply arranged to supply the first foil at a first position, a second foil supply arranged to supply the end of the second foil at a second position, and a carriage sub frame mounted to the frame so as to be movable with respect to the frame between the first position at which the first foil is supplied and the second position at which the end of the second foil is positioned. The carriage sub frame supports at least a foil end holding unit arranged for holding the end of the first foil supplied from the first foil supply. The carriage sub frame is configured to hold the end of the first foil and the end of the second foil when the carriage sub frame has moved from the first position to the second position. The device further comprises a connection unit for connecting the ends of foil, and a tape dispenser for dispensing tape to connect the foil ends. The tape dispenser is mounted on the carriage sub frame.

In EP 2 825 371 B1, the second foil is provided at the second position and aligned along a guiding block, i.e. a mechanical stop, mounted to a cutting table. When the first foil runs empty at the first position and the carriage sub frame moves to the second foil located at the second position, the carriage sub frame moves to a fixed position which corresponds to the position of the guiding block. As a position at which the first foil is being connected to the second foil is spaced from a position of the guiding block in a feeding direction (downstream direction) of the second foil, i.e. in a direction perpendicular to the moving direction of the carriage sub frame, in case the second foil has a low stiffness or low compression strength, an offset in a moving direction of the carriage sub frame may occur between a longitudinal edge of the second foil being aligned along the guiding block and the longitudinal edge of the second foil at the position at which the first foil is being connected to the second foil. Said offset may result in that the first foil can not be properly connected to the second foil by the connection unit.

In EP 2 825 371 B1, a second minor issue may occur when aligning the first foil and the second foil before being connected by the connection unit. In particular, the carriage sub frame comprises a foil alignment frame which can be tilted in order to align longitudinal edges of the first foil in a transverse direction, which is a direction perpendicular to the feeding direction of the first foil. Sensors can detect the position of the foil such that the foil alignment frame may correct the position of the foil in the transverse direction. Specifically, the first foil moves in a direction opposite to the feeding direction (upstream direction) towards the connection unit before being connected to the second foil. Meanwhile, the foil alignment frame may correct the position of the first foil in the transverse direction using the sensor. However, in case the first foil has a low stiffness or low compression strength, an offset in the transverse direction may occur between the longitudinal edge of the first foil at a position at which the sensor detects the longitudinal edge and the longitudinal edge of the first foil at the position at which the first foil is being connected to the second foil. Said offset may result in that the first foil can not be properly connected to the second foil by the connection unit.

Therefore, starting from a device as disclosed in EP 2 825 371 B1, it is an object of the invention to provide a device for connecting an end of a first foil and an end of a second foil, wherein the first foil and the second foil can be aligned to each other very precisely so that a high quality and consistency of connection between the foils is achieved. Further, it is an object of the invention to provide a method for connecting an end of a first foil and an end of a second foil, wherein the first foil and the second foil can be aligned to each other very precisely so that a high quality and consistency of connection between the foils is achieved.

These objects are achieved by the subject-matters of independent claims 1 and 8. Advantageous further developments are laid out in the dependent claims.

According to the present invention, a device for connecting an end of a first foil and an end of a second foil, comprises a frame, a first foil supply arranged to supply the first foil at a first position, a second foil supply arranged to supply the end of the second foil at a second position, and a carriage sub frame mounted to the frame so as to be movable with respect to the frame between the first position at which the first foil is supplied and the second position at which the end of the second foil is positioned. The carriage sub frame supports at least a foil end holding unit arranged for holding the end of the first foil supplied from the first foil supply, wherein the carriage sub frame is configured to hold the end of the first foil and the end of the second foil when the carriage sub frame has moved from the first position to the second position. A foil edge sensor for detecting a longitudinal edge of the second foil at the second position is mounted on the carriage sub frame.

By mounting a foil edge sensor on the carriage sub frame, when the carriage sub frame moves from the first position to the second position, the longitudinal edge, i.e. the exact position, of the second foil arranged at the second position can be reliably detected. In contrast to the device according to the prior art, in which the carriage sub frame moves to a fixed position at which the second foil is aligned along the guiding block, the device according to the invention is able to detect the actual position of the second foil. Thus, even in a case in which the second foil has a low stiffness or low compression strength, or in a case in which the second foil has been sloppy prepared by an operator, and an offset in a moving direction of the carriage sub frame occurs between a longitudinal edge of the second foil being aligned along the guiding block and the longitudinal edge of the second foil at the position at which the first foil is being connected to the second foil, the first foil and the second foil can be properly connected as the carriage sub frame moves to the actual position of the second foil using the foil edge sensor and not to a fixed position set in advance. Therefore, a high quality and consistency of connection between the first foil and the second foil can be achieved.

In a preferred embodiment, the device comprises a tape dispenser for dispensing tape to connect the end of the first foil and the end of the second foil, wherein the tape dispenser is mounted on the movable carriage sub frame and comprises two tape applicators on opposite sides of a foil trajectory, the tape applicators having generally parallel extending tape receiving surfaces, the tape applicators being arranged such that the tape applicators can move toward each other enclosing the supplied second foil in between the tape applicators so as to hold the second foil. The foil edge sensor is located such that a sensor beam of the foil edge sensor can pass through a slit provided in each of the tape applicators.

By providing the foil edge sensor such that a sensor beam of the foil edge sensor can pass through a slit provided in each of the tape applicators, the foil edge sensor is able to detect the second foil at the exact position at which the first foil and the second foil are connected. Thus, the first foil and the second foil can be aligned very precisely to each other. Accordingly, a very high quality of connection between the foils can be achieved. It should be noted that the slit is a slit different from a cutting slit of the tape applicators provided to receive a cutting knife for cutting the tape.

The device may further comprise a reflector for reflecting a sensor beam of the foil edge sensor. Specifically in a case in which the foil to be detected by the foil edge sensor is made from a transparent material which only slightly affects the sensor beam, the use of a reflector is helpful for reliably detecting the longitudinal edge of the second foil at the second position.

In a preferred embodiment, the reflector is provided at the carriage sub frame above or below the tape applicators. Accordingly, the foil edge sensor may be provided on top the tape applicators or below the tape applicators depending on the installation space available.

The reflector may be attached to a tape bin removably disposed inside the carriage sub frame. In a case in which the installation space for placing the reflector on the carriage sub frame is limited, the tape bin which is disposed below the tape applicators anyway can be used for attaching the reflector to it.

The foil edge sensor may be a photoelectric retro-reflective sensor.

In a preferred embodiment, the carriage sub frame comprises a foil alignment frame for moving the first foil relative to the carriage sub frame along a moving direction of the carriage sub frame, wherein a moving distance of the first foil is determined by using the foil edge sensor which is further configured to detect a longitudinal edge of the first foil.

The first foil moves in a direction opposite to the feeding direction (upstream direction) towards the connection unit before being connected to the second foil. The foil alignment frame may correct the position of the first foil in a moving direction of the carriage sub frame using the foil edge sensor detecting a longitudinal edge of the first foil. In particular, in a case in which the foil edge sensor is located at a position of the connection unit (the tape applicators), the first foil can be properly aligned with respect to the second foil. Thus, a very high connection quality between the first foil and the second foil can be achieved.

According to the present invention, a method for connecting an end of a first foil and an end of a second foil is provided, wherein the method comprises the steps: supplying a first foil at a first position from a first foil supply, guiding an end of the first foil held by a movable carriage sub frame from the first position towards a second position at which an end of a second foil which is supplied from a second foil supply is positioned, connecting the end of the first foil and the end of the second foil, wherein guiding the end of the first foil from the first position to the second position comprises transferring the carriage sub frame from the first position towards the second position using a foil edge sensor detecting a longitudinal edge of the second foil at the second position, wherein the foil edge sensor is mounted on the carriage sub frame.

According to the method, when guiding the end of the first foil from the first position to the second position by transferring the carriage sub frame from the first position towards the second position, a foil edge sensor mounted on the carriage sub frame detects a longitudinal edge of the second foil at the second position. Thus, the longitudinal edge, i.e. the exact position, of the second foil arranged at the second position can be reliably detected. In contrast to the device according to the prior art, in which the carriage sub frame moves to a fixed position at which the second foil is aligned along the guiding block, the method according to the invention is able to detect the actual position of the second foil. Thus, even in a case in which the second foil has a low stiffness or low compression strength and an offset in a moving direction of the carriage sub frame occurs between a longitudinal edge of the second foil being aligned along the guiding block and the longitudinal edge of the second foil at the position at which the first foil is being connected to the second foil, the first foil and the second foil can be properly connected as the carriage sub frame moves to the actual position of the second foil using the foil edge sensor and not to a fixed position set in advance. Therefore, a high quality of connection between the first foil and the second foil can be achieved.

In a preferred embodiment, the connecting the end of the first foil and the end of the second foil comprises the steps: holding the end of the first foil and the end of the second foil when the carriage sub frame has moved from the first position to the second position, and having a tape dispenser mounted to the movable carriage sub frame apply tape to the end of the second foil after having guided the end of the first foil from the first position to the second position.

In a preferred embodiment, the connecting the end of the first foil and the end of the second foil further comprises the step: aligning the first foil and the second foil using a foil alignment frame moving the first foil relative to the carriage sub frame along a moving direction of the carriage sub frame and detecting a longitudinal edge of the first foil with the foil edge sensor.

The first foil moves in a direction opposite to the feeding direction (upstream direction) towards the connection unit before being connected to the second foil. The foil alignment frame may correct the position of the first foil in a moving direction of the carriage sub frame using the foil edge sensor detecting a longitudinal edge of the first foil. In particular, in a case in which the foil edge sensor is located at a position of the connection unit (the tape applicators), the first foil can be properly aligned with respect to the second foil. Thus, a very high connection quality between the first foil and the second foil can be achieved.

### SHORT DESCRIPTION OF THE FIGURES

Examples helpful for understanding the invention and an embodiment of the invention are described in more detail in the following with the help of the appended figures, in which:

FIG. 1a shows an overview of an example of the splicer,

FIG. 1b shows a schematic overview of a system for sleeving containers using tubular foil,

FIG. 2 shows a perspective view of a carriage sub frame of a splicer device seen in the direction according to arrow II,

FIG. 3 shows a perspective view of a carriage sub frame of a splicer device according to arrow III in FIG. 1,

FIGS. 4a-4g show steps of tape dispensing on the tape applicator of a splicer device according to an example,

FIG. 5 shows a top view of the tape dispenser and tape applicator according to an example,

FIG. 6 shows a detail according to VI in FIG. 5,

FIG. 7 shows a detail of the most relevant tape applicator parts of the carriage sub frame of a splicer device,

FIGS. 8a-8h show consecutive steps for applying a tape to foil and connecting the foil ends,

FIG. 9 shows a perspective front view of a carriage sub frame of a splicer device according to an embodiment of the invention, wherein tape applicators are rotated to an open position,

FIG. 10 shows a perspective back view of a carriage sub frame of FIG. 9,

FIG. 11 shows a top view of the carriage sub frame of FIG. 9,

FIG. 11a shows a sectional view along line A-A of FIG. 11,

FIG. 11b shows an enlarged detail view of section B of FIG. 11a,

FIG. 11c shows an enlarged detail view of section C of FIG. 11b,

FIG. 12 shows a side view of the carriage sub frame of FIG. 9,

FIG. 12a shows a sectional view along line D-D of FIG. 12,

FIG. 12b shows a sectional view along line E-E of FIG. 12,

FIG. 12c shows an enlarged detail view of section F of FIG. 12,

FIG. 12d shows an enlarged detail view of section G of FIG. 12,

FIG. 13 shows a perspective front view of a carriage sub frame of a splicer device according to an embodiment of the invention, wherein tape applicators are in an position in which tape can be dispensed onto the tape applicators,

FIG. 14 shows a perspective back view of a carriage sub frame of FIG. 13,

FIG. 15 shows a top view of the carriage sub frame of FIG. 13,

FIG. 15a shows a sectional view along line A-A of FIG. 15,

FIG. 15 b shows an enlarged detail view of section B of FIG. 15a,

FIG. 15c shows an enlarged detail view of section C of FIG. 15b,

FIG. 16 shows a side view of the carriage sub frame of FIG. 13,

FIG. 16a shows a sectional view along line D-D of FIG. 16,

FIG. 16b shows a sectional view along line E-E of FIG. 16,

FIG. 16c shows an enlarged detail view of section F of FIG. 16,

FIG. 16d shows an enlarged detail view of section G of FIG. 16,

FIGS. 17a to 17d show consecutive steps for aligning a carriage sub frame with a longitudinal edge of a second foil, and

FIGS. 18a to 18d show consecutive steps for aligning a longitudinal edge of a first foil with a longitudinal edge of a second foil before connection.

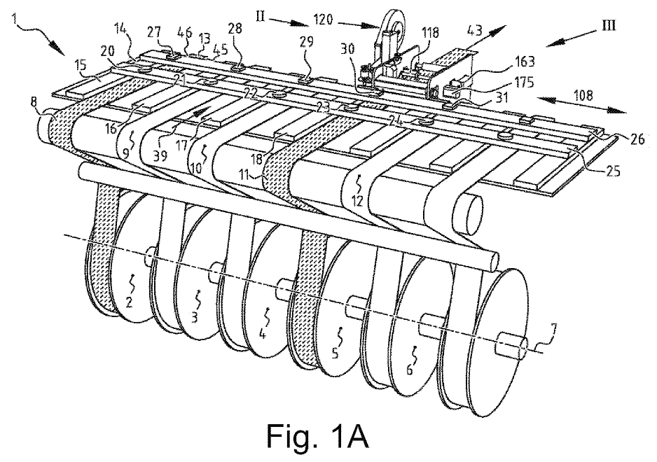

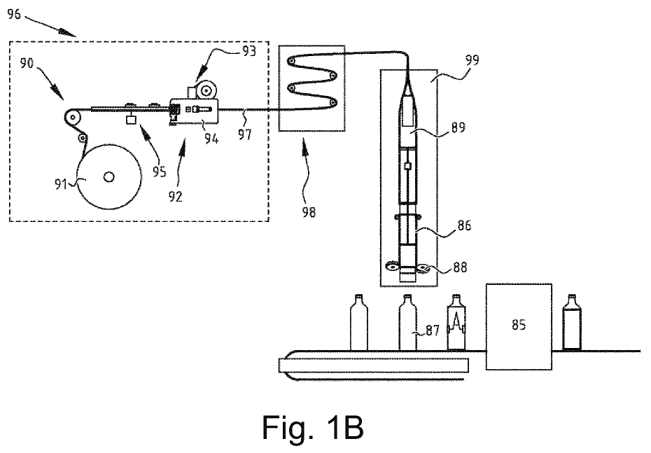

FIG. 1a shows a splicing device 1. A splicing device 1, in an example a tape splicing device, allows providing a continuous feed of foil to downstream applications of foil. In the drawing the splicer device 1 comprises a device for tape dispensing 120, a device 103,104 for applying and connecting tape to a foil and a device to connect ends of tubular foil. The splicer device is arranged to execute methods to dispense tape, to connect foil using tape, and to connect ends of foil.

In the illustrated example tubular foil of flattened form is used. Several foil supplies are provided and the splicer 1 allows connecting an end of an old foil with a beginning of a new foil. Several connection methods are available, including sealing. In the example a tape is used for connecting the tubular ends. Although the method will illustrate connecting tubular foil with two pieces of tape, clearly the example also comprises using a single piece of tape or applying tape to non-tubular foil.

Several reels 2-6 are mounted to the frame of the splicing device 1 allowing rotation around an axis 7. Each reel is mountable on a separate axle sharing the axis 7. The reels 2-6 comprise wounded tubular foil in a flattened state. The foil can be imprinted. A full reel is put into the splicing device. An empty reel 2-6 can be replaced by a new reel. The splicer 1 can have more reel positions than illustrated, such as seven, or less reel positions.

Foils 8-12 are supplied from the respective reels. The reels form the supply for flat tubular foil for further downstream processing. In other examples a single layered foil is supplied.

A leading end 13 of one of the foils is positioned on a guidance and cutting table 14. The guidance and cutting table 14 allows an operator to position a foil end in a predetermined position so as to allow further processing. The table 14 allows guidance of the foils 8-10 along guiding blocks 15-17. The guiding blocks 15-18 can be aligned with the reels. In an example the guidance and cutting table 14 comprises drives to position the (end of a) foil in a predetermined position.

The guidance and cutting table 14 also comprises individually controllable foil stops 20-24 part of a first bridge 25 that covers the foils 8-12 when they are fed over the table 14 surface. The individually controllable foil stops 20-24 allow holding the foils 8-12 in their current position. In the shown example at least foils 8-10 are locked in position.

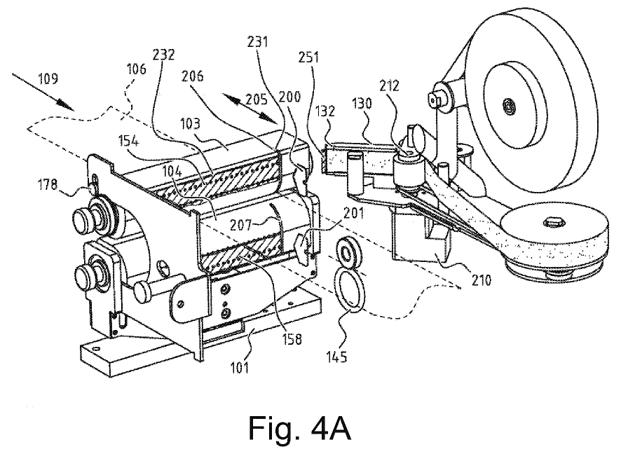

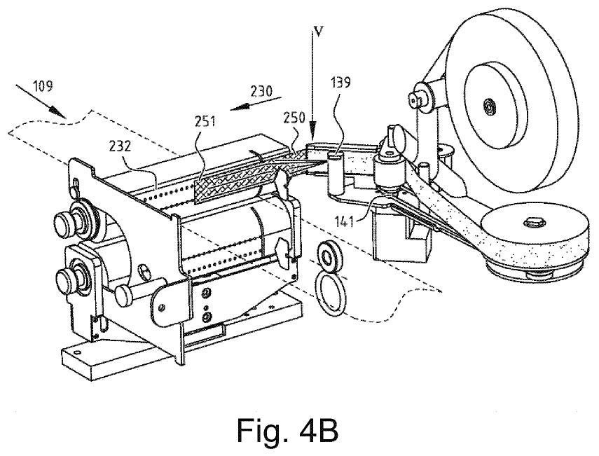

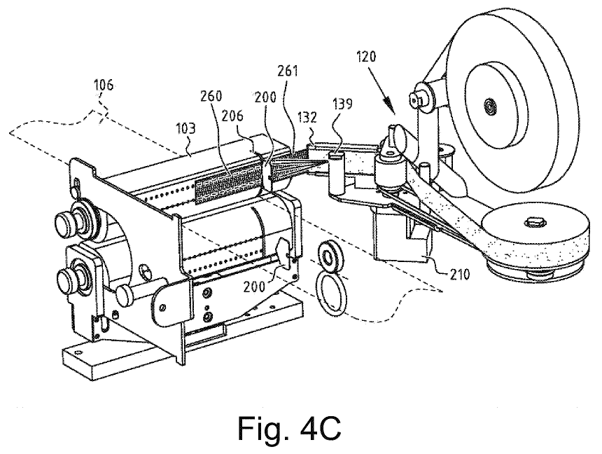

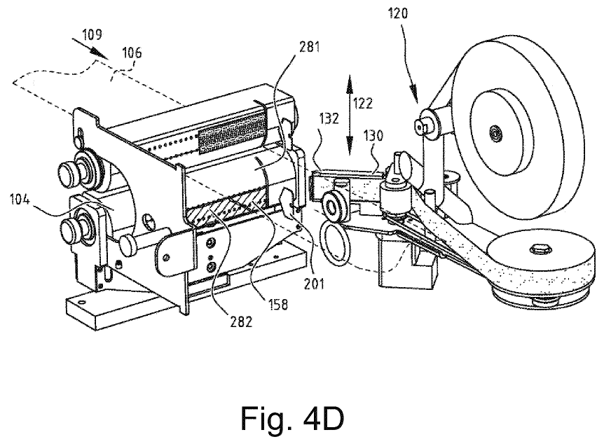

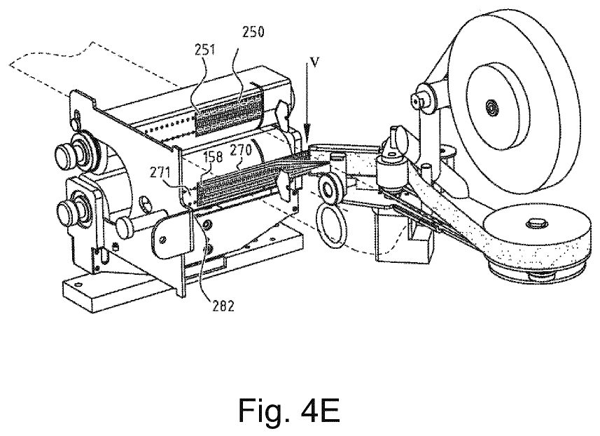

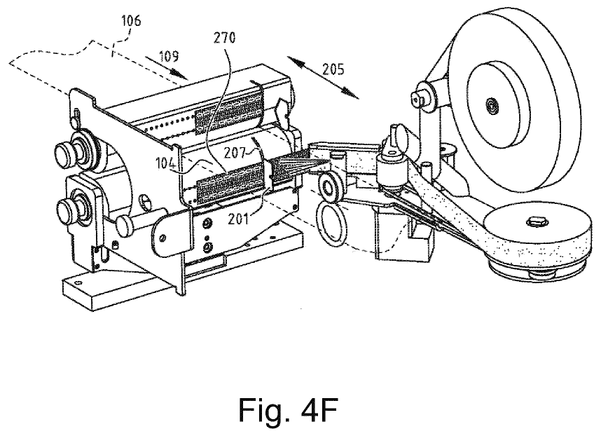

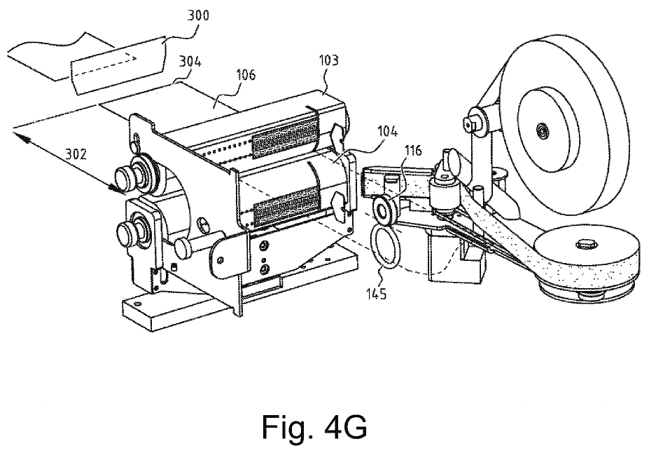

A further bridge 26 also covers the foil trajectory of the respective foils 8-12. Bridge 26 comprises individually controllable, schematically illustrated, cutting devices 27-31 that allow cutting the foil in a direction generally perpendicular to the foil feeding direction 39. An example of an actual knife part 300 of a cutting device 27-31 is shown in FIG. 4g. The table 14 can have slits positioned under bridge 26 that allow cutting the foil using knives. In an example a cutting device is mounted movably in direction 108 underneath the table 14. A single cutting device is then able to cut the supplied foil.

In the shown example foil 11 is currently being supplied from the reel 5 over the table 14, under the bridges 25,26 to a carriage sub frame 101. When the reel 5 runs empty, an end of the foil will be formed. The splicer 1 will connect the formed end with an end of a further foil supplied from one of the other reels 2-4,6.

Foils 8-10,12 supplied from reels 2-4,6 form further foils. The further foils each have an end, in this example positioned by the operator, extending somewhat from guidance and cutting table 14.

In FIG. 1a foil 11 is supplied in the foil feeding direction 39. The foil alignment unit 105 is cooperating with the guiding block 18 to feed the foil in a preferred position, specifically the alignment in the direction 110.

When foil 11 is supplied, the carriage sub frame 101 allows passage of the foil 11 for further downstream handling/processing 43. Elements on the carriage sub frame 101 surround the foil trajectory.

FIG. 1b shows a schematic overview of a device for sleeving containers.

A schematically illustrated supply 90 having a reel 91 supplies tubular foil in flattened state to a device 92 for applying to and connecting foil by tape having a tape dispenser 93. Only carriage sub frame 94 is illustrated. A schematically illustrated cutting device 95 can cut the foil and carriage sub frame 94 can move in order to allow connecting the old cut foil with a new foil from a new supply. From the splicer 96 foil 97 is fed to a buffer device 98. The buffer device 98 can contain a supply of foil. Foil is fed from the tape splicer 96 and is continuously fed further downstream. When foil supply from the splicer 96 is interrupted, e.g. when a reel runs empty, foil is fed to further downstream application from the buffer supply held in the buffer device.

Downstream from the buffer device 98 a sleeving device 99 can comprise a mandrel 89 that opens the tubular foil, cuts sleeves 86 and shoots 88 the individual sleeves over containers 87 such as bottles. Further downstream the bottles are led through an oven 85 that will heat shrink the sleeve onto the container.

In accordance to the example any of the units downstream from the supply of foil is a processing unit. The unit connecting the ends of foil are a specific example. Although in the shown example the connection unit is supported by the carriage 101, the connection unit can be mounted on other frame parts.

Now the carriage sub frame 101, in the shown example carrying the device for applying and connecting tape to a foil will be discussed in more detail.

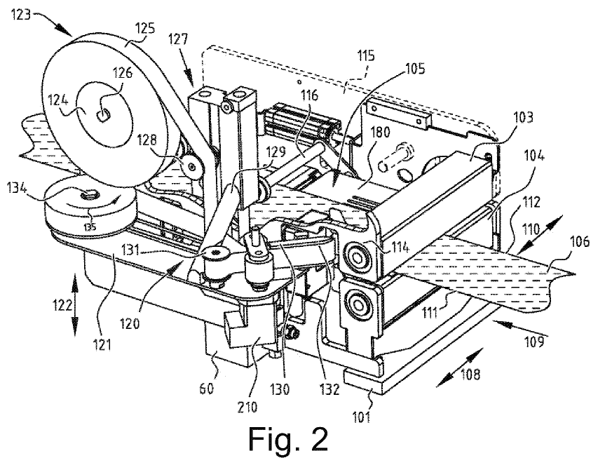

The carriage sub frame 101, shown in more detail in FIG. 2, supports a tape dispenser 120, tape applicators 103 and 104, foil alignment unit 105 and several foil 106 guiding element. Further a suitable drive is pulling the foil.

Carriage sub frame 101 is arranged in the splicer device 1 such that it can be moved according to arrow 108 with respect to the frame of the splicer device 1. A suitable drive is arranged to initiate and stop movement of the carriage sub frame in direction 108. Servo drives or other electrical drives can be used for moving the carriage sub frame 101. Suitable sensors can be arranged on either the frame of the splicer device 1 or on sub frame 101 for determining and measuring the position of the carriage sub frame 101 with respect to the splicer device/frame.

When it is determined that reel 5 is running empty, a splicing method, in a example a tape splicing method, is initiated. The foil 11 is stopped and held by stop 23. The foil 11 is cut using a knife in cutting device 30 allowing cutting the foil at a predetermined position. This will form the end edge of an ‘old’ or first foil. The operator has prepared ‘new’ or second foil ends, such as leading end 13.

In the shown example the leading end 13 is provided with an obliquely cut-away corner at both longitudinal edges, such as known from EP 1 201 585 A1 from the same applicant. In an example a single layered foil is supplied having no pre-processed leading end.

The tubular foil 8 comprises at least two layers of foil connected near the edges. By cutting that edge, and in an example by removing a part of the foil, the leading end 13 now comprises two layers that can be separated somewhat from each other. The cut-aways form loose lips that can be separated from each other, i.e. the mouth of the leading end 13 can be opened. In another example the lips are separated by cutting the side edge without removing material.

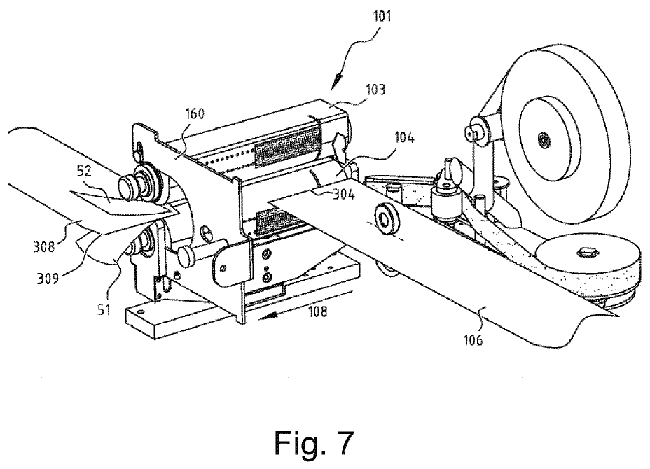

After cutting the foil 11 and transporting the formed end 304 downstream such that it is positioned inside the carriage sub frame, see e.g. FIG. 7, carriage sub frame 101 can e.g. move from that first position towards a second position close to leading end 13. On both transverse sides the carriage sub frame 101 has guiding wings 51,52 that allow receiving the leading end 13 in between the wings 51,52 and as a result in between tape applicators 103,104 as will be described in more detail. In further subsequent steps, because of the predetermined position of leading end 13, a splicing method connecting the ends of foil, can be executed.

In any example a first position of a foil end is a position of a foil end formed when the supply (reel) runs (close to) empty. A second position is a position close to an end of a further foil to which the formed end is to be connected. In the shown examples the difference between a first and second position is in a direction 108 and can be overcome by transferring the carriage sub frame 101 in the direction 108.

In any example a foil end holding unit can any of the processing units positioned along the foil trajectory that offers some control over the position of the end of the foil. The formed end of the foil is received in the carriage sub frame as a result of conveying the foil further downstream. The foil end holding unit doesn't have to actually engage the foil end.

The operator can replace the empty reel 5 by a new reel and position the new foil on the table 14 in the predetermined position.

Returning to FIG. 2, foil 106 is supplied in direction 109 from a reel with winded tubular foil. The tubular foil 106 will pass tape applicators 103, 104 positioned on opposite sides of the foil trajectory.

The position of the foil in the transverse direction 110 of the foil supply is guided and adjusted using the foil aligning unit 105. Suitable sensors determine and measure the position of the foil 106 and in particular sides 111 and 112 of foil 106 and, if needed, foil aligning unit 105 will engage foil 106 to correct the position of the foil in the transverse direction 110 back to a default position. The default position of the foil 106 is the position of the foil in which foil connection can be made. A position sensor can e.g. detect the side position of the foil 106.

Registration sensor 204 is arranged to monitor the foil and in particular the prints on the foil. Connecting the old foil and new foil is to be arranged such the repetitive print remains at the same pitch. Therefore the pitch is determined at the sensor 204 allows cutting at a predetermined position, e.g. exactly in between the prints.

Foil alignment unit 105 is connected to drive 60, in an example a servo motor, that will move the alignment frame 180, e.g. by tilting, in the direction in order to align edges of the foil in the default position with regard to the transverse direction 110.

In order to allow an overview of the device, many of the frame parts are shown either only partially, such as frame part 114 or are shown with dotted lines 115, such as frame part 115.

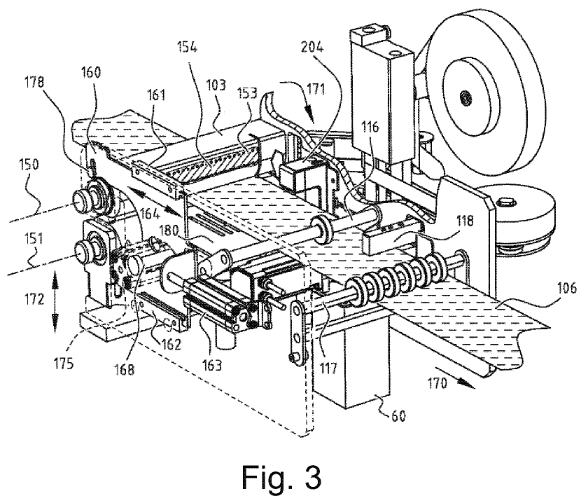

A downwardly biased arm 116 will force the foil 106 in a downward direction onto a wheel 145, see FIGS. 3 and 4. Wheel 145 has a fixed position with bearing with respect to the foil alignment frame 180. It can be driven. In an example the wheel 145 and arm 116 cooperate to e.g. brake the movement of the foil 106, e.g. when the supply of foil is running empty.

A further downstream rigid arm 117 comprising bearings with rollers prevents upward movement of the foil. After arm 117, foil 106 can bend upwards (not shown).

When foil 11 is supplied from the reel 5 the alignment unit and foil feed are continuously aligning/driving the foil.

The tape dispenser is generally indicated with reference numeral 120 and is positioned sideways from the foil 106 along a side of the carriage sub frame 101. The tape dispenser 120 is positioned on a further sub frame 121 that can be moved with respect to carriage sub frame 101 according to arrow 121 in an upward and downward direction using suitable drive.

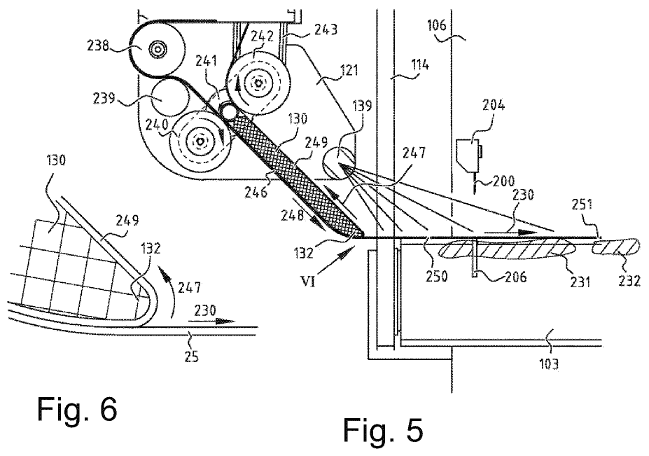

Tape dispenser 120 comprises a tape supply 123. In this example the tape supply 123 comprises tape 125 with protection sheet winded around a reel 124 that can rotate around an axis 126. Tape is supplied in direction 127 and guided by wheels 128 and an angled guide 129 that guides the tape into a generally upright position around wheel 131 with a generally upright axis and towards tooth 130. A detailed view of the tooth 130 is shown in FIGS. 5 and 6 and will be discussed in more detail hereunder.

In the examples shown, the tape dispenser sub frame 121 supports not only the tape dispenser 120 but also the tape supply and tape cover sheet discharge, but these are examples.

The protective sheet is guided over the tape dispensing end 132 of the tooth 130 back towards a collecting reel 134 having an upright axis that collects protective sheeting by winding in direction 135. In this example reel 134 is driven in direction 135 in order to collect protective sheeting.

Tape applicator 103 is rotatably mounted on carriage sub frame 101. Tape applicator 103 has a rotation axis 150 and tape applicator 104 has a rotation axis 151. Tape applicator 103 comprises a partially rounded generally rectangular tube having holes 153 on tape receiving surface 154 that is shown shaded in FIG. 3. The tape applicator 103 is connected to a vacuum source (not shown) that can apply a vacuum that will invoke a sucking force using openings 153 that will suck a tape onto the tape receiving surface 154.

The tape applicator 103 can be driven around tape rotation axis 150 by a suitable drive 163. The same or a further drive, or using a transmission, can drive tape applicator 104 around rotation axis 151. Suitable servo motors can be applied and the rotation of tape applicators 103 and 104 can be synchronous.

FIG. 4a shows the tape dispenser driving unit 210 connected to roll 212 that can pull the tape protective layer over the tape dispensing end 132 of tooth 130.

Although according to the illustrated example tape applicator 103 will receive a piece of tape, other examples are possible. Tape applicator 103 can also comprise a tape dispenser or an adhesive supply or sealing device is provided on the tape applicator 103. The executed methods using the tape applicator 103 (or tape applicator 104) is in no way limited to using a tape.

Tape applicator 104 can move in the direction according to arrow 172 using a suitable drive such as a servo motor. This allows moving the tape applicators towards each other, in this case moving only a single tape applicator 104, to enclose on the foil in between the tape applicator. This will allow applying and connecting tape onto both opposite sides of the flattened tubular tape foil ends.

Now first a method and device will be described for dispensing tape. Clearly other means for making to the connection between a first foil end and a second foil end could be applied in combination with other elements or methods according to this description.

FIG. 4a shows an initial position while foil 106 is being supplied in the downstream direction 109 from the flattened tubular foil supply. Suitable sensors are arranged to determine and measure whether the supply from the reel is running out. At a predetermined moment or after measuring a predetermined signal, the tape dispensing will be initiated followed by the tape applying and tape connecting. In FIG. 4a a splicer state is shown wherein the tape dispenser is ready for tape dispensing.

In the initial tape dispenser state as indicated in FIG. 4a, the tape dispenser end 132 is located generally in the same horizontal plane as the top tape applicator 103 and the tape receiving surface 153. As a result of this positioning, a part 231 from the tape receiving surface part 153 is located close to the tape dispensing end 132 and a part 232 is located more remote. The more remote part 232 is positioned at a larger distance from the tape dispensing end 132 than the part 231.

FIG. 4b shows the initiated tape dispensing. From the tape dispensing end 132 tape 250 is dispensed in direction 230 and moved away from the tape dispensing end 132. The tape leading end 251 will reach the tape applicator 103, first at part 231 and, when the dispensing is continued, move in the direction of the remote part 232.

As shown in more detail in FIGS. 5 and 6, during dispensing the actual tape and protective sheet 246 is moved along 248 over tooth 130 in the direction of end 132 and the tape protective sheet 249 is pulled off from the actual tape 250 near the tape dispensing end 132 and continues in direction 247, while actual tape 250 is dispensed in direction 230.

FIG. 5 shows a detail of FIGS. 4b and 4e according to arrow V in FIG. 4b providing a top view. Tape and protective sheeting 246 is provided from a supply and guided between rollers 240, 241 rotating around upright axes.

Roller 242 is connected by a belt 243 to reel 134. Rollers 240,241 and 242 are in frictional direct contact with each other. Tape+protective sheeting and tape sheeting is guided between the respective rollers 240,241,242. One of these rollers 240 can be connected to a suitable drive unit 210. The combined construction of transmissions (frictional/belt) allows drive 210 to drive rollers 240-242 and reel 134. Further rollers 238,239 guide the tape 246.

During the dispensing action as shown in FIG. 4b, a nozzle 139, positioned on the tape dispenser sub frame 121 is switched on and directs gas, such as air, towards the tape 250 being dispensed, pushing the tape 250 onto the tape receiving surface 154 of tape applicator 103. As the nozzle 139 is directed along the tape dispensing direction 230, a somewhat laminar flow of gas will provide a “pushing” force pushing the tape 250 onto the tape receiving surface 154.

A suitable tape 250 is used. Preferably the tape has at least a predetermined amount of rigidity, allowing a horizontal dispensing of the tape while maintaining a generally horizontal direction of the tape without supporting the dispensed end against rotational forces. Preferably the tape stiffness is at least enough to dispense tape in the horizontal direction over at least 5 cm, preferably 8 cm, more preferably 10 cm. A suitable tape is aluminum tape.

In an example an additional force can be provided for maintaining a generally horizontal extension of the tape 250 while being injected from the tape dispenser by providing a (limited) vacuum inside the tape applicator 103. This results in a sucking force of the tape 250 onto the tape receiving surface 154 through the holes 153/154.

While the tape 250 is being dispensed, the tape leading end 251 is moved in the tape dispensing direction 230 passing the proximal part 231 and eventually reaching the remote part 232 of the tape receiving surface 154. The tape end 251 reaches the tape receiving surface accordingly without any other mechanical driving other than the actual tape dispensing, e.g. by pulling the protective layer using the dispensing driving unit 210 and roller 212. This reduces the mechanical complexity of tape dispensing.

During the tape dispensing foil can still be fed in the feeding direction 109 from the (still not empty) reel.

In this application a (finite) remote part 232 of the tape receiving surface is any part of the tape receiving surface that is located more remote than a (finite) proximal part 231 of the tape receiving surface. The remote part does not have to be the most remote part of the tape receiving surface.

In the examples according to FIGS. 4b and 4c, the remote part 232 is a part halfway the tape applicator 103 seen in the direction 230 from the tape dispenser. In this example FIG. 4b shows the end position of the tape end 251 when tape dispensing is completed in direction 230. In other examples the tape end 251 is moved more remote in tape dispensing direction 230, while, tape dispensing could also have ended more prematurely, bringing the tape end 251 only at one-third or even one-fourth or one-fifth of the total tape receiving surface.

When tape dispensing in the tape dispensing direction 230 has ended, the dispensed tape 250 is locked into position onto the tape receiving surface 154 by applying a vacuum in the tape applicator 103 sucking the tape onto the tape receiving surface 154 through the holes 153. Until or even after locking the tape into position onto the tape receiving surface by the vacuum, the gas nozzle 139 can provide its supporting pushing force.

FIGS. 4a and 4c show tape cutting knives 200 and 201. Tape cutting knife 200 is received in a (not shown) cutting device comprising a house and e.g. an air cylinder that allows displacing the knife 200. The cutting knives can move in direction 205 into a cutting slit 206 provided in tape applicator 103 and cutting slit 207 in tape applicator 104 respectively. This will allow cutting the tape that is provided on the tape receiving surface.

After the tape reaching the end position on the tape receiving surface 154, the tape dispensing in direction 230 is stopped.

When the tape has reached the end position, and preferably after locking the tape into position, the dispensed tape 250 is cut using the schematically illustrated cutting device by driving the knife 200 into the slit 206. This action will separate a part of the dispensed tape 260 from the tape 261 still connected to the tape dispenser. The separated tape part is held onto the tape receiving surface 154 by applying the vacuum.

In an example the tape part extending beyond the tape dispensing end 132 can be retracted e.g. by driving the tape dispenser drive in an opposite direction. In other examples part is not retracted or is cut off by an auxiliary cutting device. In the following figures however, the tape extending beyond the tape dispensing end is removed.

FIG. 4d shows the tape dispenser 120 in a second position wherein the tape dispenser sub frame 121 is moved in a generally vertical direction 122 with respect to the tape applicator 103, 104 such that the tape dispenser end 132 is now generally in the same plane as the tape applicator 104 and the tape receiving surface 158. The position of the tape dispenser 120 is generally similar to the initial state although the tape dispenser 120 is now in line with the tape applicator 104.

Although the tape dispenser sub frame 121 is guided in the direction 122 generally perpendicular to the foil trajectory, also other guide directions are possible, e.g. v-shaped.

Generally the same sequence of tape dispensing is executed again, now dispensing tape onto the tape applicator 104. Accordingly, a single tape dispenser is used for applying tape to the tape applicators 103, 104 positioned on opposite sides of the foil moving between the two tape applicators. This results in a substantial saving for cost, while a single guide and drive is needed only. The tape dispenser drive and guide for arranging and controlling the movement in direction 122 of the tape dispenser sub frame 121 with respect to the tape applicators 103,104 and tape receiving surfaces is not shown in FIGS. 4a-4g.

Generally the tape dispenser end 132 moves from a first position in which the tape dispenser end is directed at the tape applicator 103 and the tape receiving surface 154 to a second position directed at the other tape applicator 104 and other tape receiving surface 158.

In an example the foil 106 is still being dispensed from the reel in the foil transport direction 109, as shown in FIG. 4d, when the tape dispenser moves downward to the other tape receiving surface.

In FIG. 4e tape dispensing a second piece of tape 270 with a second tape leading end 271 onto the second tape applicator 104 having a second tape receiving surface 158 is illustrated. The tape is fed from the tape dispensing end 132 and extends there from. The second tape leading end 271 first reaches a proximal part 281 of the second tape receiving surface 158 and is dispensed further so as to reach a less proximal, that is more remote part 282 of the second tape receiving surface 158.

Tape dispensing is in the shown examples generally in a horizontal direction wherein the tape extending from the tape dispensing end 132 is unsupported against gravity other than by its internal stiffness and a connection that is maintained with the supply of tape. Some support is offered by a pushing force exerted by a gas flow provided from the nozzle 139.

When tape is dispensed e.g. in a downward vertical direction, in another example, the gas nozzle can prevent curling of the tape back to a winded state.

The tape dispensing is ended when the second tape end 271 reaches a predetermined remote part 282 of the tape receiving surface 158 while further a surface area of tape 270 covers more proximal parts of the tape receiving surface 158. The second tape is then locked into position by providing a vacuum resulting in a sucking force of the tape 270 onto the tape receiving surface 158. Generally, a length of tape is dispensed generally similar to the first tape, still being held on tape receiving surface of tape applicator 103.

Thereafter the dispensed tape 270 is cut using cutting device having a knife 201 that is moved in direction 205 into a slit 207 provided in tape applicator 104 as shown in FIG. 4a. This can be followed by possible retraction of the tape end still extending beyond the tape dispensing end 132.

During the second tape dispensing steps, foil can still be provided from the reel in direction 109. In this example providing the second tape onto the tape applicators and the tape dispensing sequence and can start before the actual tape connection sequence. Preferably the tape dispensing sequence is started a predetermined time before the reel from the foil is empty. Foil can still be continuously supplied during the tape dispensing sequence.

As a last step of the tape dispensing sequence the tape dispenser can be moved back to its initial position, or a following tape dispensing sequence can start with the tape dispensing sub frame located adjacent the second tape applicator 104.

In FIG. 4g a cutting device 30 (as shown in FIG. 1a) having a knife 300 positioned upstream from the tape applicators 103,104 along the foil trajectory, cut the foil 106, at a predetermined distance 302 upstream from the tape applicators. The result is that a predetermined length 302 of foil is available, and a suitable controller can drive the foil in foil transport direction 109 e.g. using the wheel 145 and counter wheel 116 to pull the foil and foil edge 304 in foil transport direction 109. Because the length of the foil is known, exact positioning of the foil edge 304 is possible.

The cutting device 30 can be part of the table 14 as illustrated in FIG. 1.

FIG. 7 illustrates the (partially shown) carriage sub frame 101 moving in a transverse direction 108 with respect to the guidance and cutting table 14 driven by a suitable driver. The foil end 304 of the old foil is conveyed somewhat downstream and held in a predetermined position with respect to the carriage sub frame 101 and tape applicators 103,104. The splicer device 1 allows transverse movement 108 of the carriage sub frame 101 holding the foil end 304 while maintaining the foil connection with further downstream processing units such as a buffer device.

The carriage sub frame is, when ‘old’ foil is supplied positioned at the first position. The end of the next or further foil is positioned at the second position and the carriage sub frame can be moved, guided or transferred from the first position towards and to the second position.

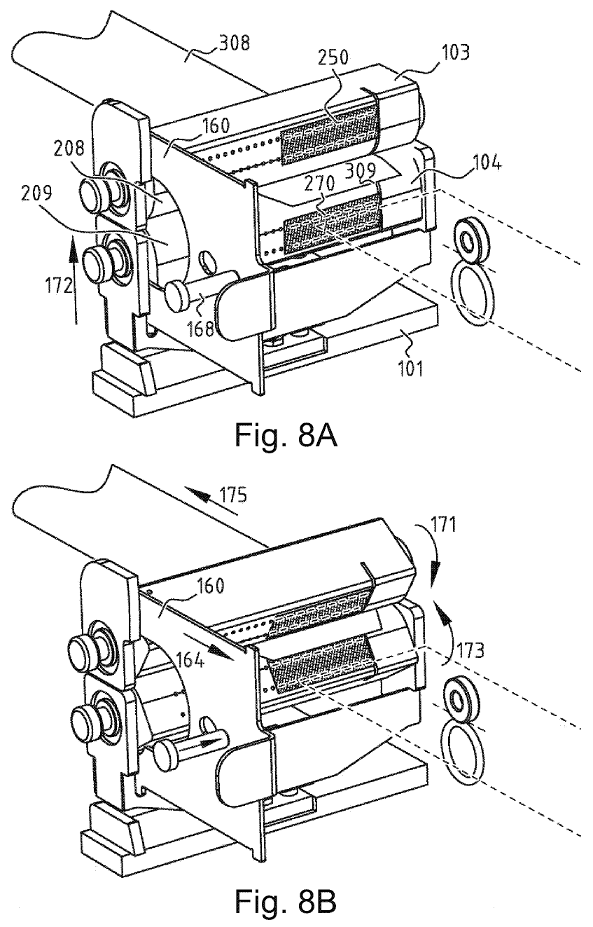

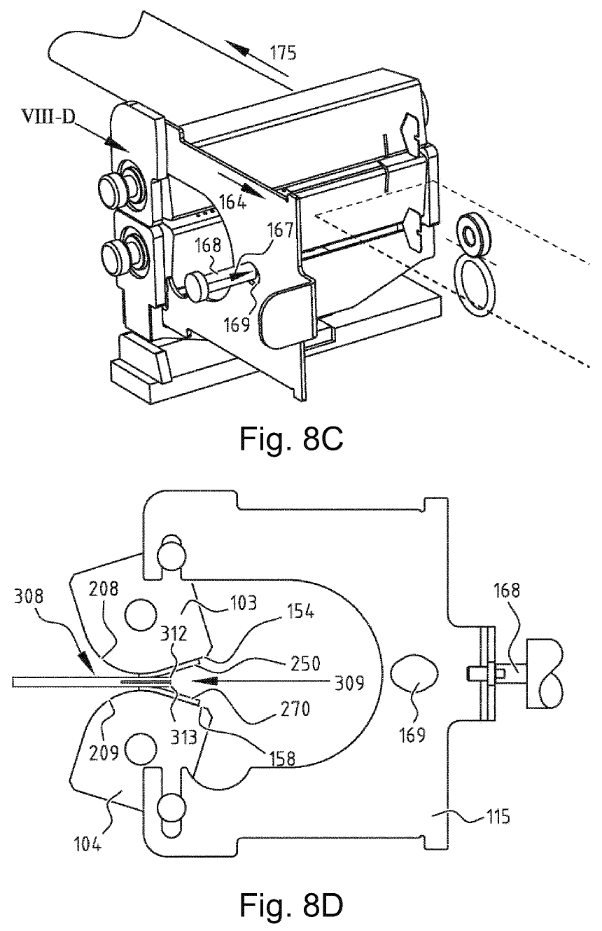

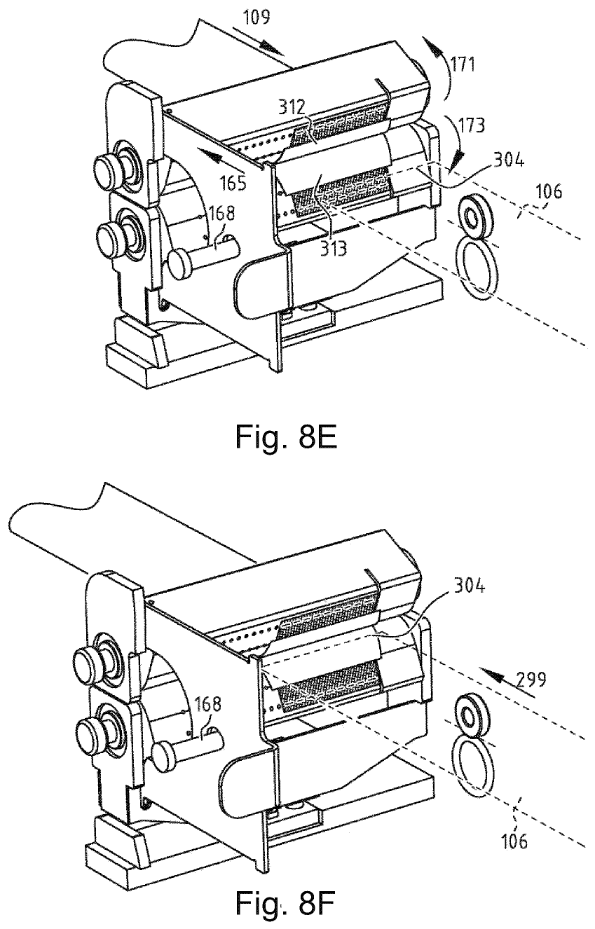

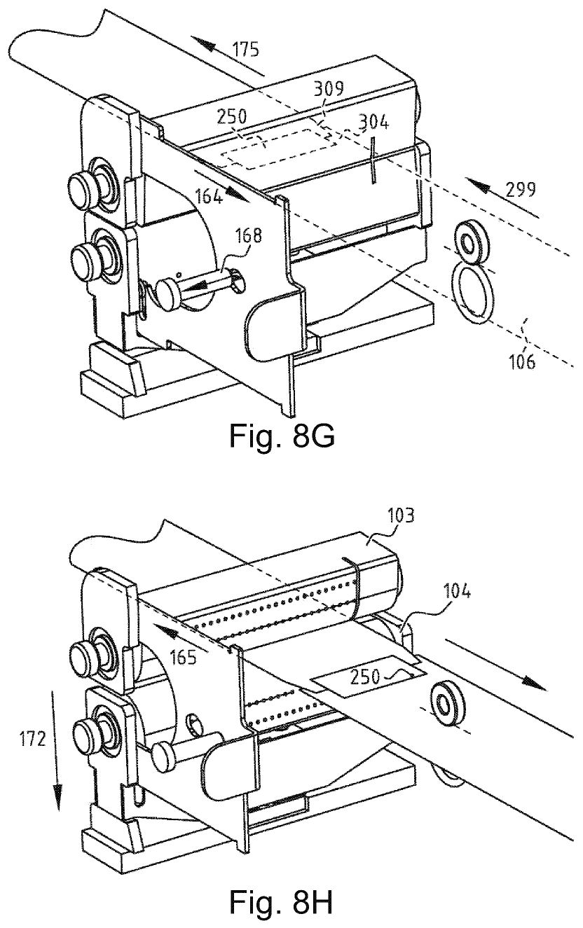

A foil 308 is supported by the guidance and cutting table 14 in a predetermined position. The foil end 309 has partially removed edges which will allow opening the layers of the tubular foil 308 near end 309. In the predetermined position end 309 will run in between wings 51,52 on carriage sub frame 101 which will bring the end 309 between tape applicators 103,104. Again as a result of the predetermined position of end 309, carriage sub frame 101 is moved over a certain distance allowing the end 309 to be aligned with end 304. The edges of both foils 308 and foil 106 can be aligned. In an example further sensors allow the alignment. The aligned position is shown in FIG. 8a as the initial position of the method for applying and connecting the ends of tubular foil in a splicing device 1 using tape.

Aligning end 304 of the ‘old’ foil 106 with pieces of tape 154,158 and especially with foil end 309 of a ‘new’ foil 308 can comprise an engaging device (not shown) arranged to engage foil 106 close to end 304, said engaging device connected to sensors for sensing a (relative) position of end 309 and the engaging device arranged to move at least sideward 110 so as to align the longitudinal edges of the respective foils 106 and 308. In an example the tape receiving surfaces are mounted in the splicer 1 movable in direction 110 so as to allow alignment of the foil ends after applying tape.

Further such an engaging device can fix the relative position of the end 304 with respect to the table frame 101. The engaging device can be positioned on opposite sides of the foil trajectory and can comprise suction units.

A first step of the illustrated method according to FIG. 8a comprises driving tape applicator 104 in direction 172. Tape applicator 104 is moved towards tape applicator 103. Foil 308 is held between the two tape applicators. The foil end 309 extends in the downstream direction beyond the tape applicators. The foil 308/foil end 309 is still in the predetermined position when held on the guidance and cutting table 14. Stop 20-24 can still be locked, locking the foil 308 in position. During or after the first step of the method stop 20-24 is unlocked.

A suitable drive moves tape applicator 104 with respect to carriage sub frame 101.

Tape applicators 103,104 are rotatably held around axis 150,151 with respect to the carriage sub frame 101. Several bearing constructions and drives are possible.

In the illustrated example synchronous rotation of the tape applicators 103,104 is arranged using frame plate 160 that is guided by horizontal guides 161, 162, see FIG. 2. The guides 161, 162 allow frame plate 160 to move in direction 164. Frame plate 160 is connected to servo motor or air cylinder 163.

By moving frame plate 160 in the downstream direction of arrow 164, pin 178 on one end of the tape applicator 103 is engaged, as well is a similar pin on tape applicator 104 (not shown). Tape applicator 103 will rotate according to arrow 171. Simultaneously, a likewise engagement on tape applicator 104 will rotate tape applicator 104 in the opposite direction 173 as shown in FIG. 8b.

In this example, as tape applicator 104 is moved according to arrow 172, the foil 308 is held between the tape applicators 103,104. Accordingly the rotation of the tape applicators will move the foil 306 in an upstream direction 175. Specifically the rounded surface area 208,209 of the tape applicators will engage on the foil 208. This cylindrical surface area will point contact the foil 308. Foil 106 is still held in the predetermined position.

The tape applicators 103, 104 continue to rotate while frame plate 160 moves in direction 164. A blocking pin 168 will prevent further movement of the plate 160 as blocking pin 168 is biased 167 to enter through hole 169. As soon as blocking pin 168 enters the hole 169, further movement/rotation is blocked. This will prevent the two tapes 250,270 from sticking together. FIG. 3 shows an air cylinder 175 for operating the pin 168.

Hole 169 is larger than the circumference of pin 168. When pin 168 is received in hole 169, the plate 160 can still be moved in either direction 164 or 165. The orifice of hole 169 provides a domain within which plate 160 can move, and thereby a domain of angles for rotation of the tape applicators 103, 104.

Rotation of the tape applicators 103, 104 continues to such an extent, about 75-85°, that the tape receiving surface and tapes 250,270 still held onto the tape receiving surfaces 154, 158 will come into contact with the foil 308 and in particular close to foil end 309. A cross sectional view is shown in FIG. 8d indicated by arrow VIII-d in FIG. 8c.

The adhesive side of tape 250,270 will come into contact with the upper 312 and lower 313 layers of the foil 308/foil end 309 respectively. Tape is now applied to the foil end 309 of one of the foils to be connected using the splicer 1.

Blocking pin 168 prevents the further rotation. As a result rotation of the tape applicators such that tape 250/270 will come in contact with each other is prevented. According to the method the predetermined position of foil end 309 is such that only a part of the tapes 250/270 will come in contact with the respective layers 312,313 of the foil 308. If rotated too far, the tapes would come into contact with each other. The blocking pin 168 prevents rotation beyond the indicated position in FIG. 8d.

As a result of the adhesive contact a subsequent reverse movement of the frame plate 160 by driving the plate 160 in direction 165 as shown, the engaged layers (or lips) 312,313 and foil 308 will be pulled in a downstream direction as a result of rotation 171/173. The tapes 250,270 will stick to the layers 312,313 opening the mouth of foil end 309 as shown in FIG. 8e. About 50% of the tape 250,270 is sticks to layers 312,313.

Pin 168 is still extended in FIG. 8e in hole 169. Hole 169 is shaped such that plate 160 can move and rotation of the tape applicators to the opened mouth position according to FIG. 8e can be obtained. Pin 168 delimits the rotation of the tape applicator to e.g. a domain between 45 and 85 degrees.

The opened foil end 309 can now receive the foil end 306 of the first foil 106 still held in a predetermined position between the separated lips. As a result of the predetermined position a drive can feed the ‘old’ foil 106 in an upstream direction according to arrow 299 into the opened foil end 309 as illustrated in FIG. 8f. The method provides for feeding the old foil a predetermined distance in the upstream direction.

The foil end 304 is supported e.g. by table 180 of the foil alignment unit 105. This table, having an edge shortly downstream from the tape applicators 103,104 guides the end 304 into the opened mouth.

The upstream feeding according to arrow 299 is continued in a subsequent step in combination with moving the frame plate 160 and thereby rotating the tape applicators and moving the ‘new’ foil in an upstream direction 175. Now pin 168 is unbiased (or retracted) and moving of the frame plate is not stopped by the pin 168 entering the through hole 169. Instead the plate 160 is moved beyond the position according to the FIG. 8d.

Accordingly after feeding the foil 106 in the upstream direction into the opened lips of the new foil 308, feeding in the upstream direction is continued now together with feeding the new foil 308 also in the upstream direction.

Accordingly the example allows the combined upstream feeding of the old foil 106 and new foil 308 in particular for applying the pieces of tape 154, 158, already applied to the leading edge 309 of the new foil, to the ‘old’ foil 106, thereby making the connection between the foil ends.

As a result the complete tape 250,270 is applied onto the foil ends 309/304. The foil ends 304,309 are connected.

In a subsequent step the tape applicator 104 is moved downwards 172 allowing the foil to freely move between the tape applicators 103,104 and the frame plate 160 is returned to its initial position, rotating the tape applicators back to the initial position, as shown in FIG. 8h.

In an example the foil 106,308 is provided with markers, e.g. markers along the edge of the foil, e.g. positioned at a predetermined pitch. The markers allow an exact positioning of the foil with respect to a marker sensor positioned along the foil trajectory.

In an example the number of markings is counted, allowing to count whether the supply of foil is running empty, as a reel of foil has a predetermined number of markings at predetermined pitch positioned on the supplied foil. The skilled person will be able to arrange suitable markers, suitable sensors and adapt the above described method for positioning accordingly.

### Embodiment

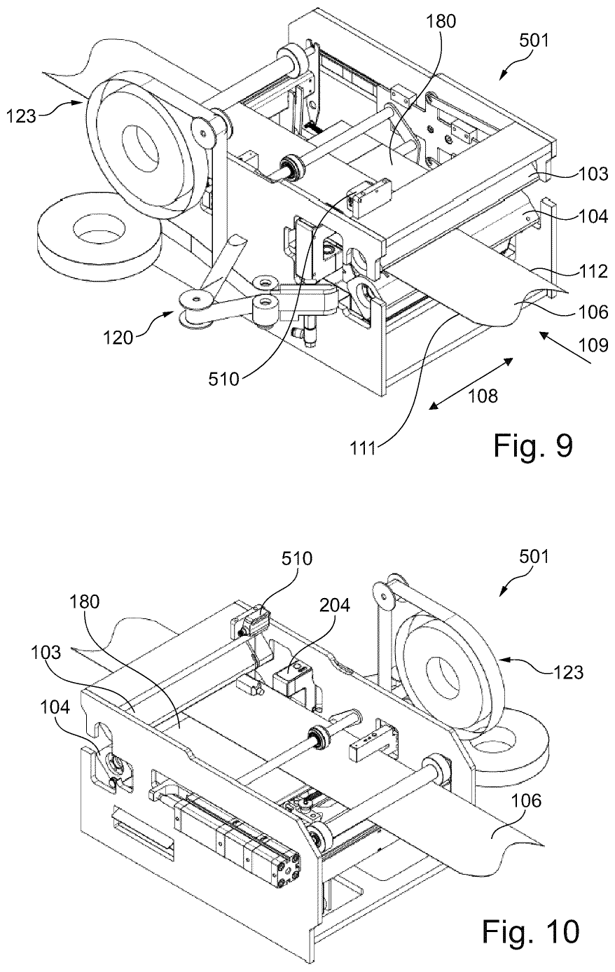

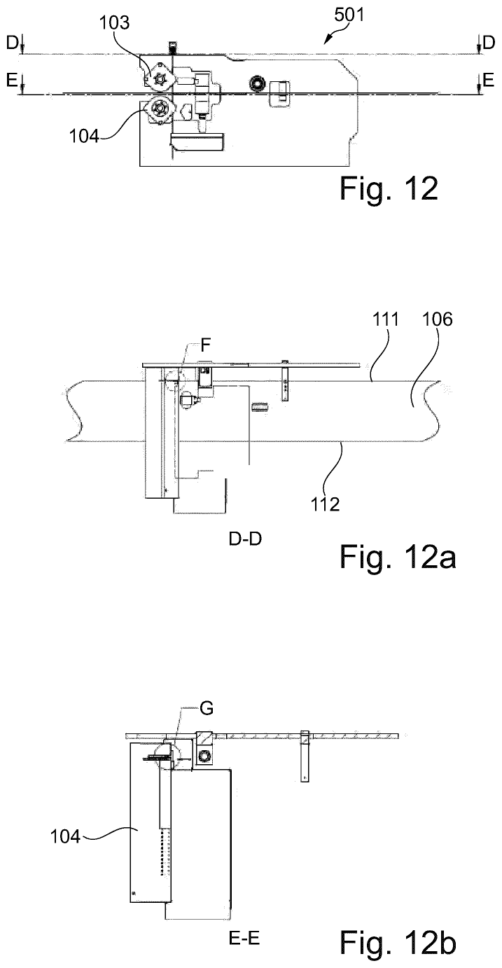

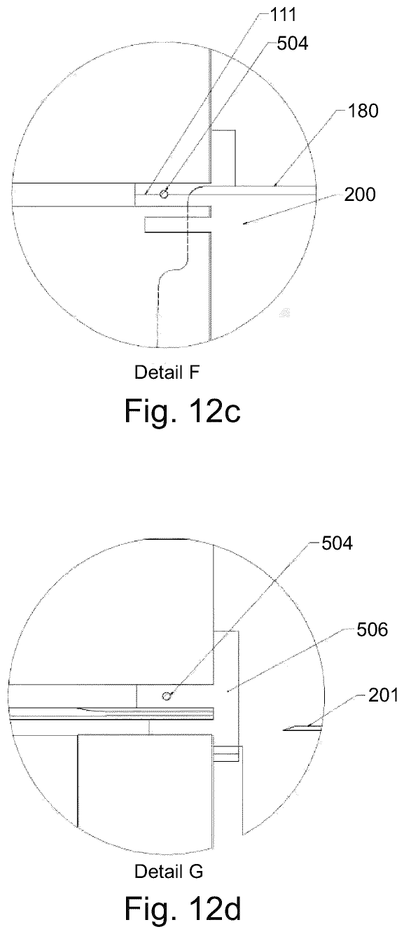

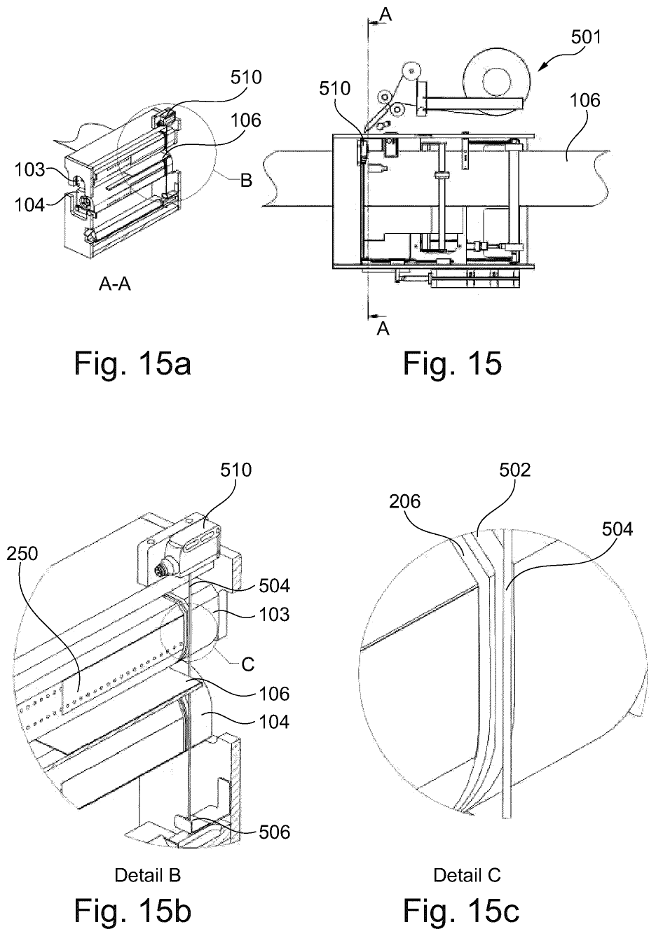

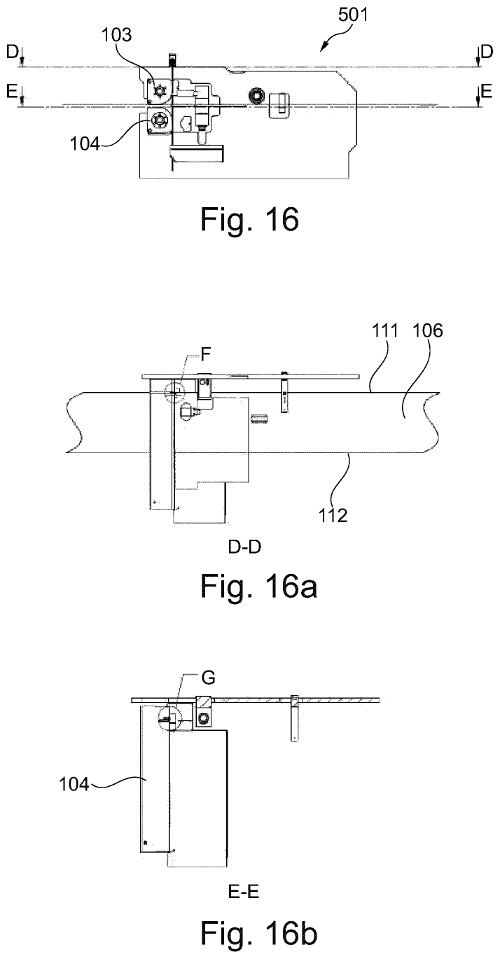

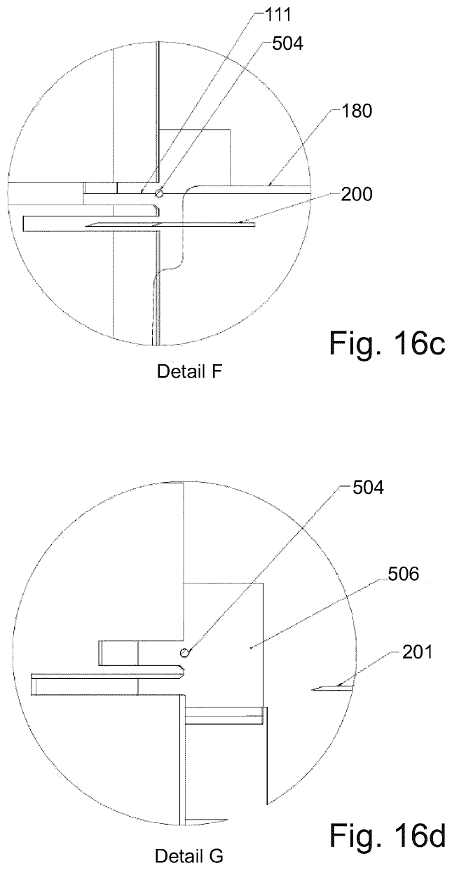

In the following, a device for connecting an end of a first foil and an end of a second foil according to an embodiment of the invention is described with reference to FIGS. 9 to 18d. The basic structure and functioning of the device of the embodiment corresponds to the basic structure and functioning the splicing device 1 according to the above described example with respect to FIGS. 1 to 8h. Therefore, in the following description, only the differences compared to the splicing device 1 as shown in FIGS. 1 to 8h will be discussed. Elements of the device of the embodiment corresponding to elements of the splicing device 1 are provided with the same reference signs where it seems appropriate.

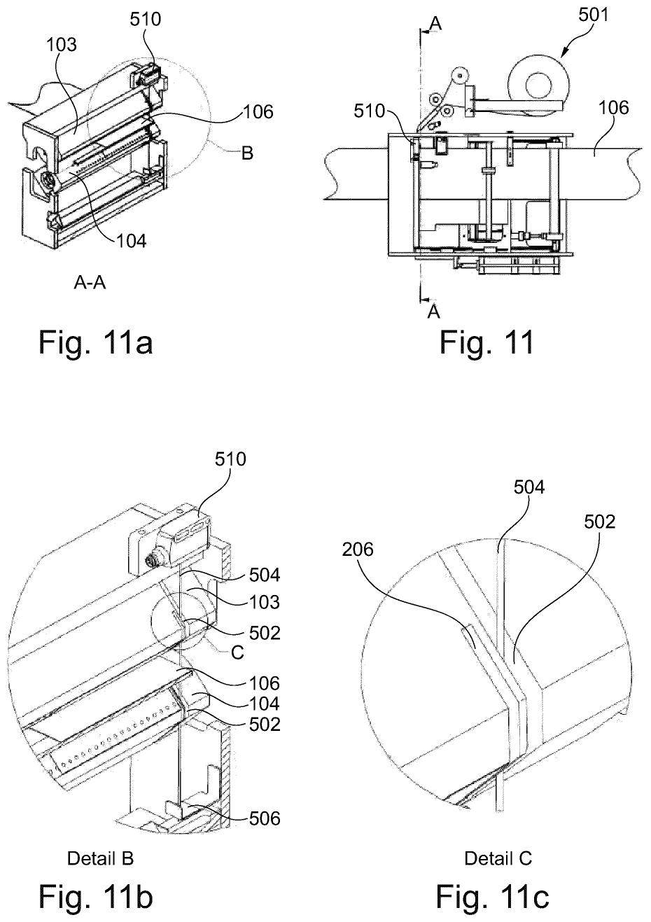

Specifically, the device of the embodiment differs from the splicing device 1 as shown in FIGS. 1 to 8h by a carriage sub frame 501 as shown in FIGS. 9 and 10. A foil edge sensor 510 for detecting a longitudinal edge 311 of the second foil 308 at the second position and for detecting the longitudinal edge 111 of the first foil 106 is mounted on the carriage sub frame 501. In particular, as shown in FIGS. 11 to 11c, the foil edge sensor 510 is located on top of tape applicator 103 such that a sensor beam 504 of the foil edge sensor 510 can pass through a slit 502 provided in each of the tape applicators 103, 104. By providing the foil edge sensor 510 on top of tape applicator 103 and by providing the slit 502 in each of tape applicators 103, 104, the sensor beam 504 is able to detect the longitudinal edge 311 of the second foil 308 and to detect the longitudinal edge 111 of the first foil 106 substantially at the position at which the tape applicators 103, 104 apply pieces of tape to the leading edge 309 of the second foil 308 before finally connecting the first foil 106 to the second foil 308. The slit 502 is located next to the slit 206 provided for receiving the knifes 201, 202 for cutting the tape. A reflector 506 which reflects the sensor beam 504 is provided below the tape applicators 103, 104. The reflector 506 is attached to a tape bin (not shown in detail) removably disposed inside the carriage sub frame 501.

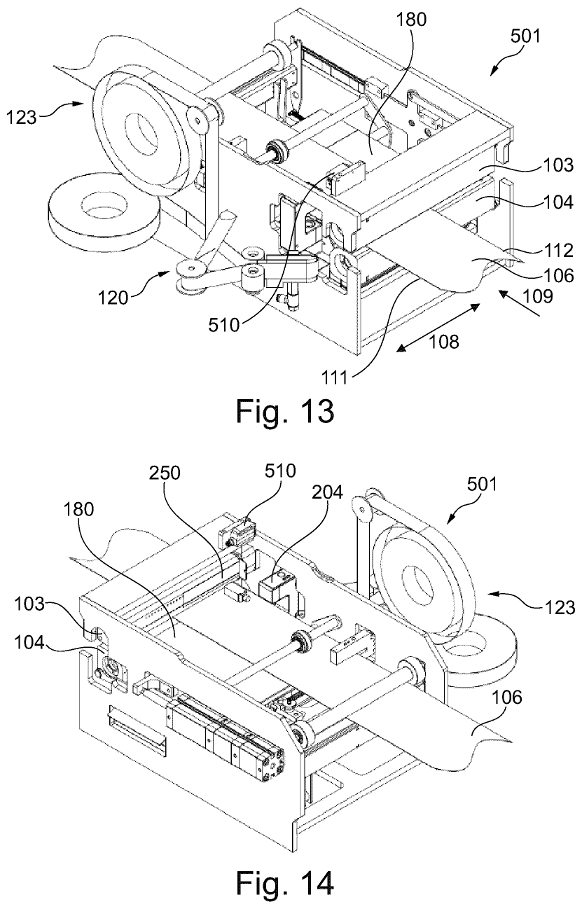

FIGS. 13 to 16d correspond to FIGS. 9 to 12d showing the carriage sub frame 501 having mounted the foil edge sensor 510 for detecting the longitudinal edge 311 of the second foil 308 at the second position and for detecting the longitudinal edge 111 of the first foil 106, however, the tape applicators 103, 104 being rotated to a position in which the tape 250 can be dispensed onto the tape applicator 103. That is, FIGS. 13 to 16d show a state in which the reel from which foil 106 is supplied is about to become empty and carriage sub frame 501 moves in direction 108 to the second position at which the second foil 308 has been prepared.

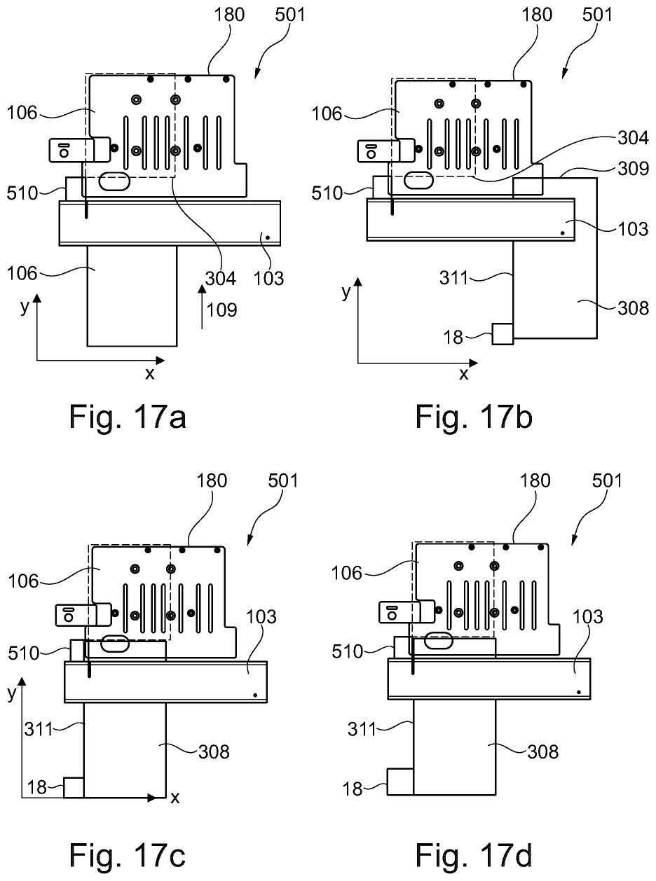

FIGS. 17a to 17d schematically show consecutive steps for aligning the carriage sub frame 501 with the longitudinal edge 311 of the second foil 308. FIG. 17a shows a state in which it has been detected that the reel from which the first foil 106 is supplied in direction 109 at the first position runs empty and therefore, the first foil 106 is cut (not shown). Next, the cut foil end 304 is guided from the first position to the second position by transferring the carriage sub frame 501 having the foil edge sensor 510 in direction X, as shown in FIG. 17b. As soon as the foil edge sensor 510 mounted on the carriage sub frame 501 detects the longitudinal edge 311 of the second foil 308 aligned at the guiding block 18, carriage sub frame 501 stops, as shown in FIG. 17c, and possibly moves back in a direction opposite to direction X such that the sensor beam 504 of the foil edge sensor 510 is positioned exactly on the longitudinal edge 311 of the second foil 308, as indicated in FIG. 17d.

By performing the steps as shown in FIG. 17a to 17d, the exact position of the longitudinal edge 311 of the second foil 308 can be detected. Even if an offset due to a low stiffness or low compression strength of the second foil 308 in direction X of the second foil 308 occurs between the longitudinal edge 311 of the second foil 308 being aligned with the guiding block 18 and the longitudinal edge 311 of the second foil 308 at a splicing position between the tape applicators 103, 104, a high quality and consistency of connection between the first foil 106 and the second foil 308 can be achieved as the foil edge sensor 510 detects the exact position of the second foil 308 at the splicing position between the tape applicators 103, 104.

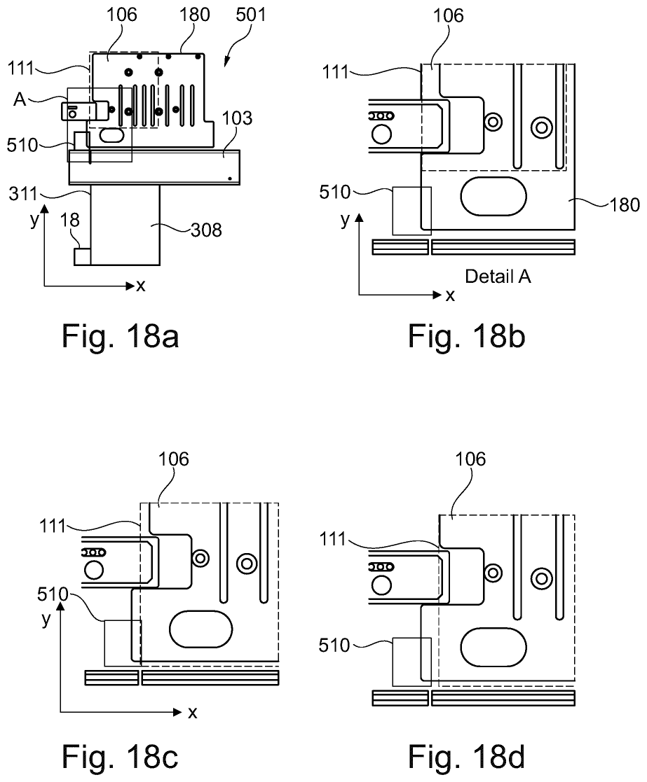

FIGS. 18a to 18d schematically show consecutive steps for aligning the longitudinal edge 111 of the first foil 106 with the longitudinal edge 311 of the second foil 308 before the foils 106, 308 are connected. FIGS. 18a and 18b show a state in which the carriage sub frame 501 has been moved to the second position by detecting the longitudinal edge 311 using the foil edge sensor 510. Having arrived at the second position, the first foil 106 is moved towards the tape applicators 103, 104 in a direction opposite to direction Y in order to be connected to the second foil 308. As shown in FIG. 18c, after the foil edge sensor 510 has detected the first foil 106, the first foil 106 is moved in direction X, i.e. in the moving direction of the carriage sub frame 501, relative to the carriage sub frame 501 by the foil alignment frame 180 until the foil edge sensor 510 is no longer detecting the first foil 106, as shown in FIG. 18d. In case the first foil 106 is not detected by the foil edge sensor 510 after having moved over a certain distance in a direction towards the tape applicators 103, 104, i.e. in a direction opposite to direction Y, the first foil 106 is moved in a direction opposite to direction X relative to the carriage sub frame 501 until the foil edge sensor 510 detects the longitudinal edge 111 of the first foil 106.

It is again noted that FIGS. 17a to 18d are only schematical drawings for describing the working principle of the device according to the embodiment. Thus, FIGS. 17a to 18d do not limit the structure or position of any of components of the device according to the embodiment. For example, in FIGS. 17a to 17d, the foil edge sensor 510 is located slightly in front of tape applicator 103 in foil transport direction 109 of the second foil 308 in order to being able to show how the foil edge sensor 510 detects the longitudinal edge 311 of the second foil 308, while FIGS. 9 and 10, for example, show that the foil edge sensor 510 is located on top of (above) the tape applicator 103.

By performing the above described steps, the exact position of the longitudinal edge 111 of the first foil 106 can be detected at the position at which the first foil 106 and the second foil 308 are to be connected, i.e. at the splicing position between the tape applicators 103, 104. As a result, a very high quality and consistency of connection between the first foil 106 and the second foil 308 can be achieved by using the foil edge sensor 510 mounted on the carriage sub frame 501.

1. Device for connecting an end of a first foil and an end of a second foil, the device comprising:
a frame;
a first foil supply arranged to supply the first foil at a first position;
a second foil supply arranged to supply the end of the second foil at a second position;
a carriage sub frame mounted to the frame so as to be movable with respect to the frame between the first position at which the first foil is supplied and the second position at which the end of the second foil is positioned, the carriage sub frame supporting at least a foil end holding unit arranged for holding the end of the first foil supplied from the first foil supply, wherein the carriage sub frame is configured to hold the end of the first foil and the end of the second foil when the carriage sub frame has moved from the first position to the second position, and
a foil edge sensor for detecting a longitudinal edge of the second foil at the second position is mounted on the carriage sub frame;
whereby the exact position of the longitudinal edge of the second foil is detected by aligning the carriage sub frame with the longitudinal edge of the second foil as follows:
detecting that the reel from which the first foil is supplied in direction at the first position runs empty;
cutting the first foil;
guiding the cut foil end from the first position to the second position by transferring the carriage sub frame having the foil edge sensor in a direction X;
detecting the longitudinal edge of the second foil aligned at a guiding block by the foil edge sensor;
stopping carriage sub frame; and
positioning sensor beam of the foil edge sensor exactly, so that a longitudinal edge of the first foil and the longitudinal edge of the second foil align.

2. Device according to claim 1, comprising a tape dispenser for dispensing tape to connect the end of the first foil and the end of the second foil wherein the tape dispenser is mounted on the movable carriage sub frame and comprises two tape applicators on opposite sides of a foil trajectory, the tape applicators having generally parallel extending tape receiving surfaces, the tape applicators being arranged such that the tape applicators can move toward each other enclosing the supplied second foil in between the tape applicators so as to hold the second foil wherein the foil edge sensor is located such that a sensor beam of the foil edge sensor can pass through a slit provided in each of the tape applicators.

3. Device according to claim 1, further comprising a reflector for reflecting a sensor beam of the foil edge sensor.

4. Device according to claim 3, wherein the reflector is provided at the carriage sub frame above or below the tape applicators.

5. Device according to claim 3 or 4, wherein the reflector is attached to a tape bin removably disposed inside the carriage sub frame.

6. Device according to claim 1, wherein the foil edge sensor is a photoelectric retro-reflective sensor.

7. Device according to claim 1, wherein the carriage sub frame comprises a foil alignment frame for moving the first foil relative to the carriage sub frame along a moving direction of the carriage sub frame wherein a moving distance of the first foil is determined by using the foil edge sensor which is further configured to detect a longitudinal edge of the first foil.

8-10. (canceled)

11. Device according to claim 1, wherein the exact position of the longitudinal edge of the second foil can be detected even if an offset due to a low stiffness or low compression strength of the second foil in the direction X of the second foil occurs between the longitudinal edge of the second foil being aligned with the guiding block and the longitudinal edge of the second foil at a splicing position between the tape applicators, a high quality and consistency of connection between the first foil and the second foil can be achieved as the foil edge sensor detects the exact position of the second foil at the splicing position between the tape applicators.

12. Device according to claim 2, further comprising a reflector for reflecting a sensor beam of the foil edge sensor.

13. Device according to claim 12, wherein the reflector is provided at the carriage sub frame above or below the tape applicators.

14. Device according to claim 4, wherein the reflector is attached to a tape bin removably disposed inside the carriage sub frame.

15. Device according to claim 2, wherein the foil edge sensor is a photoelectric retro-reflective sensor.

16. Device according to claim 3, wherein the foil edge sensor is a photoelectric retro-reflective sensor.

17. Device according to claim 4, wherein the foil edge sensor is a photoelectric retro-reflective sensor.

18. Device according to claim 5, wherein the foil edge sensor is a photoelectric retro-reflective sensor.

19. Device according to claim 2, wherein the carriage sub frame comprises a foil alignment frame for moving the first foil relative to the carriage sub frame along a moving direction of the carriage sub frame, wherein a moving distance of the first foil is determined by using the foil edge sensor which is further configured to detect a longitudinal edge of the first foil.

20. Device according to claim 3, wherein the carriage sub frame comprises a foil alignment frame for moving the first foil relative to the carriage sub frame along a moving direction of the carriage sub frame, wherein a moving distance of the first foil is determined by using the foil edge sensor which is further configured to detect a longitudinal edge of the first foil.

21. Device according to claim 4, wherein the carriage sub frame comprises a foil alignment frame for moving the first foil relative to the carriage sub frame along a moving direction of the carriage sub frame, wherein a moving distance of the first foil is determined by using the foil edge sensor which is further configured to detect a longitudinal edge of the first foil.

22. Device according to claim 5, wherein the carriage sub frame comprises a foil alignment frame for moving the first foil relative to the carriage sub frame along a moving direction of the carriage sub frame, wherein a moving distance of the first foil is determined by using the foil edge sensor which is further configured to detect a longitudinal edge of the first foil.

23. Device according to claim 6, wherein the carriage sub frame comprises a foil alignment frame for moving the first foil relative to the carriage sub frame along a moving direction of the carriage sub frame, wherein a moving distance of the first foil is determined by using the foil edge sensor which is further configured to detect a longitudinal edge of the first foil.
